(19) United States
(12) Patent Application Publication
(10) Pub. No.: US 2017/0361813 A1
(43) Pub. Date: Dec. 21, 2017

(54) Hitch Receiver Stand

(71) Applicant: David Anderson, Dorr, MI (US)

(72) Inventor: David Anderson, Dorr, MI (US)

(21) Appl. No.: 15/626,772

(22) Filed: Jun. 19, 2017

Related U.S. Application Data
(60) Provisional application No. 62/351,554, filed on Jun. 17, 2016.

(51) Int. Cl. B60S 9/04; F16M 11/16; B60S 9/02

(52) U.S. Cl. CPC B60S 9/04; F16M 11/16; B60S 9/02

(57) ABSTRACT

A hitch receiver stand comprises a hitch receiver assembly having a hitch receiver than can removably mount a device having a standard hitch and is removably attached to a framework. The framework may include a number of releasably coupled components.

### CROSS-REFERENCE TO RELATED APPLICATION

This application claims priority from U.S. Pat. App. Ser. No. 62/351,554 filed Jun. 17, 2016, entitled “Hitch Receiver Stand,” the entire disclosure of which is hereby incorporated by reference in its entirety.

### BACKGROUND OF THE DISCLOSURE

1. Field of the Disclosure

The disclosure relates in general to frame and stands, and more particularly, to a hitch receiver stand which can accept a device intended for coupling to a hinge to allow use of the device remote of the vehicle and a hitch coupled to a vehicle.

2. Background Art

Many consumer vehicles, especially trucks and SUVs are provided with a hitch receiver that removably mounts a device equipped with a hitch, such as hitch baskets, bike racks, and the like. These vehicle-mounted devices are often used to transport items, which have utility away from the vehicle, such as when camping. While very useful for transportation purposes, such vehicle-mounted devices are in the way when the vehicle is parked and can prevent a user from opening a back door of the vehicle. Furthermore, the user must often park the vehicle away from the site where items are to be used. For example, when camping, vehicles must often be parked away from the campsite. It is inconvenient to have to return to the parked vehicle every time a user needs an item on the vehicle-mounted device.

A convenient apparatus is needed that allows a user to removably mount a device having a hitch.

### SUMMARY OF THE DISCLOSURE

The disclosure is directed to a hitch receiver stand for removably mounting a device having a hitch comprises a hitch receiver assembly and a collapsible framework. The hitch receiver assembly comprises a hitch receiver that removably mounts a standard hitch. The framework comprises four leg supports, a pair of base supports, and a pair of braces. Two of the leg supported are angled to offset the center of gravity of the hitch receiver stand away from the mounted device to increase the stability of the hitch receiver stand.

In an aspect of the disclosure, the disclosure is directed to a hitch receiver stand comprising a hitch receiver assembly and a plurality of leg supports. The hitch receiver assembly includes at least one hitch receiver defining a passage. The pair of leg supports are coupled to the hitch receiver. The leg supports are configured to support the hitch receiver assembly off a ground surface so that the hitch receiver is spaced apart therefrom.

In some configurations, the plurality of leg supports further comprise a pair of first side leg supports and a pair of second side leg supports. Each of the leg supports extending oblique to the hitch receiver.

In some configurations, the first side leg supports define a first side plane and the second side leg supports define a second side plane. The first and second side planes being oblique to each other.

In some configurations, the first side leg supports and the second side leg supports are mirror images of each other taken about a plane bisecting the hitch receiver.

In some configurations, the stand further includes a first base support extending between the pair of first side leg supports, proximate a distal end thereof, and a second base support extending between the pair of second side leg supports.

In some configurations, the first base support is releasably attachable to each of the pair of first side leg supports. The second base support is releasably attachable to each of the pair of second side leg supports.

In some configurations, the pair of first side leg supports are releasably attachable to the hitch receiver assembly. And, the pair of second side leg supports are releasably attachable to the hitch receiver assembly.

In some configurations, the stand further includes a brace that extends between the pair of first leg supports and the pair of second leg supports.

In some configurations, the hitch receiver further includes a plurality of inserts, each of which extends outwardly therefrom. The plurality of leg supports are attachable to one of the plurality of inserts.

In some configurations, each of the plurality of leg supports extends one of inside one of the plurality of inserts, and, over one of the plurality of inserts.

In some configurations, the at least one hitch receiver comprises at least two hitch receivers configured in a spaced apart configuration.

In some configurations, the at least two hitch receivers comprises two hitch receivers that are aligned vertically and spaced apart from each other, and substantially parallel to each other.

In some configurations, the plurality of leg supports are coupled to the hitch receiver assembly proximate an upper one of the at least two hitch receivers.

In some configurations, the plurality of leg supports comprises four leg supports.

In some configurations, the four leg supports define a footprint. The hitch receiver assembly being positioned within the footprint defined by the four leg supports.

In some configurations, the hitch receiver further includes a flat plate extending thereover.

In some configurations, leg supports are configured to maintain the passage of the hitch receiver in a substantially parallel orientation relative to the ground surface.

In some configurations, the leg supports have a circular cross-sectional configuration.

In some configurations, the plurality of leg supports are releasably coupled to the hitch receiver assembly.

In some configurations, the hitch further includes a plurality of base supports. Each base support releasably coupled to a distal end of at least one of the plurality of leg supports.

### BRIEF DESCRIPTION OF THE DRAWINGS

The disclosure will now be described with reference to the drawings wherein:

FIG. 1 of the drawings is a perspective view of a hitch receiver stand according to the present disclosure;

FIG. 2 of the drawings is an exploded view of the hitch receiver stand of FIG. 1;

FIG. 3 of the drawings is a perspective view of the hitch receiver stand, with a hitch mounted to the hitch receiver stand;

FIG. 4 of the drawings is a perspective view of another configuration of the hitch receiver stand of the present disclosure;

FIG. 5 of the drawings is a top plan view of the configuration of the hitch receiver stand of the present disclosure shown in FIG. 4;

FIG. 6 of the drawings is a side elevational view of the configuration of the hitch receiver stand of the present disclosure shown in FIG. 4;

FIG. 7 of the drawings is a front elevational view of the configuration of the hitch receiver stand of the present disclosure shown in FIG. 4;

FIG. 8 of the drawings is a perspective view of the hitch receiver assembly of the hitch receiver stand of the present disclosure shown in FIG. 4; and

FIG. 9a through 9c of the drawings is another configuration of the hitch receiver stand of the present disclosure, showing a collapsible version thereof.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

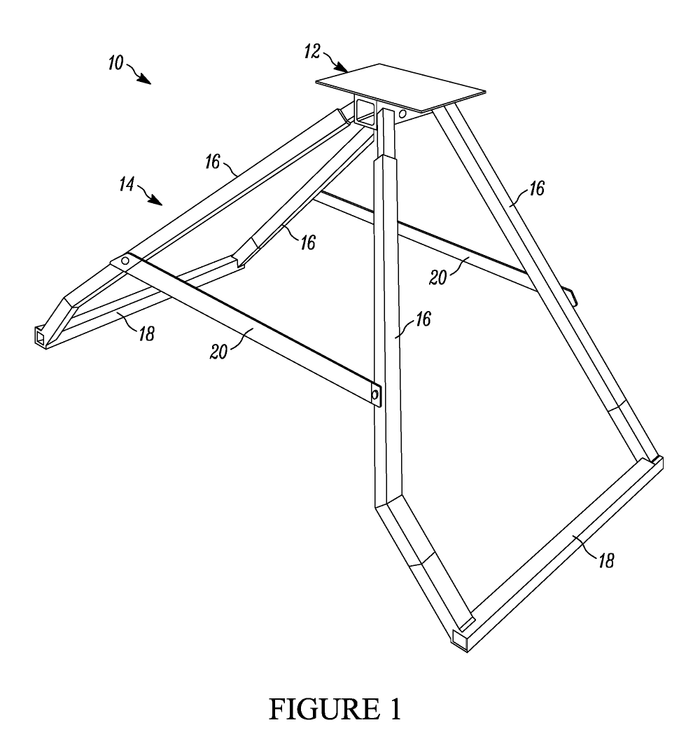

Referring now to the drawings and in particular to FIG. 1, a hitch receiver stand 10 according to the invention comprises a hitch receiver assembly 12 removable mounted to a collapsible framework 14. The framework 14 comprises four leg supports 16, a pair of base supports 18, and a pair of braces 20. The base supports 18 are adapted to rest on a surface, with the leg supports 16 extending generally upwardly at convergent angles from the base supports 18 to mount the hitch receiver assembly 12. The braces 20 extend between adjacent pairs of the leg supports 16. The components of the hitch receiver stand 10 are preferably constructed of metal, such as aluminum or lightweight steel.

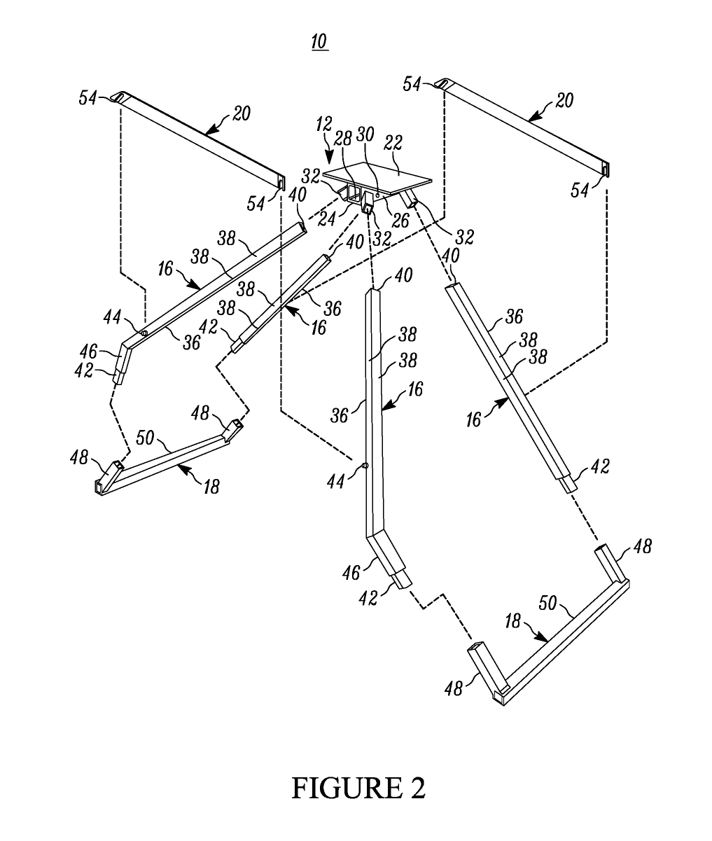

Referring to FIG. 2, the hitch receiver assembly 12 comprises a generally flat plate 22 with a hitch receiver 24 fixedly attached to one side of the plate 22, preferably by welding an outer surface of the hitch receiver 24 to the flat plate 22, although other methods of attachment can be used. The hitch receiver 24 is tubular in shape, and comprises four spaced side walls 26 defining a generally square passage 28. A pair of aligned holes 30 are formed in the two walls 26 that are perpendicularly orientated with respect to the flat plate 22. The passage 28 is adapted to receive a standard hitch that is common to vehicle-mountable devices, such as hitch baskets bike racks, and the holes 30 receive a corresponding hitch pin to secure the hitch within the passage 28. The passage 28 thus has the same dimensions as a standard vehicle hitch receiver, which are commonly a 2″ receiver or a 1.25″ receiver.

A number of inserts 32 extend away from the receiver assembly 12. The inserts 32 correspond to the number of leg supports 16, and have an aperture 34 with a generally square cross-section. The inserts 32 are fixedly attached to the side walls 26 of the hitch receiver 24 and extend downwardly at divergent angles from the hitch receiver 24. The inserts 32 can be welded to the hitch receiver 24. The inserts 32 can alternately be fixedly attached to the flat plate 22.

The leg supports 16 have a tubular body 36 comprising four side walls 38 having a generally square cross section, although any other cross-sectional shape can be used. An insert receiver 40 is located at one end of the body 36, and an support insert 42 at an opposite end thereof. A boss 44 for mounting the braces 20 extends from one side wall 38 of each leg support 16. Two of the leg supports 16 have generally straight bodies 36 and two of the leg supports 16 have body 36 with an angled portion 46. The angled portion 46 of the leg supports 16 serve to offset the center of gravity of the hitch receiver stand 10 away from the vehicle-mountable device so that the hitch receiver stand 10 is stable and will not tip over with the weight of the vehicle-mountable device.

The insert receiver 40 is dimensioned to telescopically receive the insert 32 on the hitch receiver assembly 12. The support insert 42 is dimensioned to be telescopically received within a support insert receiver 48 on the ground support 18. The support insert 42 preferably has a smaller diameter than the body 36. The ground supports 18 have a generally tubular body 50, with the support insert receivers 48 extending orthogonally from the ends of the body 50. The braces 20 are generally flat and have a pair of spaced notches 54 that slidingly receive the screw bosses 44 on the leg supports 16. It will be understood that in some configurations, one or both of the braces can be eliminated. It will further be understood that in other configurations, alternate bracing structures (such as cross-braces) may be employed. In still other configurations, the leg supports can be inserted and can terminate separately without having a base support extending therebetween. Yet other structures may have leg supports that couple to more than two leg supports, such as, for example, a ring that is coupled to each of the leg supports. Moreover, it is contemplated that a greater number of leg supports, that is, in excess of four may be utilized (as well as three supports in other configurations). In the configuration shown, the first side legs define a plane and the second side legs define a plane with the planes being oblique to each other and generally mirror images of each other about a plane vertically bisecting the hitch receiver.

The assembly of the hitch receiver stand 10 will now be described, however, it will be understood that the invention is not limited to the particular order of assembly described herein. The leg supports 16 are attached to the hitch receiver assembly 12 by inserting the inserts 32 into the insert receivers 40. The base supports 18 are attached to the leg supports by inserting the support inserts 42 into the support insert receivers 48. The braces 20 are attached to the leg supports 16 by sliding the notches 54 over the bosses 44.

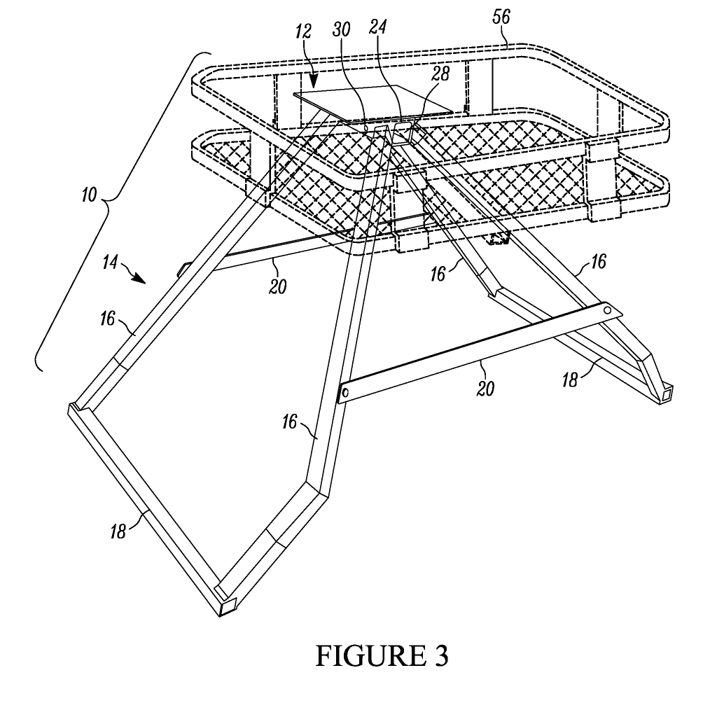

Referring to FIG. 3, an example of a vehicle-mountable device is shown mounted to the assembled hitch receiver stand. A hitch basket 56 is removably mounted to the hitch receiver stand 10 by inserting the hitch of the hitch basket 56 into the passage 28 of the hitch receiver 24. The hitch pin (not shown) of the hitch is then inserted through the holes 30 to secure the hitch within the passage 28. Advantageously, the hitch basket extends into an area wherein at least some of the leg supports extend therebelow. It will be understood that such a positioning provides inherent stability as the basket (or other device) can be coupled to the hitch receiver and have portions which remain within the footprint of the base.

The hitch receiver stand 10 of the invention is collapsible, allowing for compact storage of the stand and portability. The hitch receiver stand 10 is furthermore lightweight and easy to assemble. The leg supports 16 and ground supports 18 are preferably hollow to decrease the weight of the framework 14. While components of the hitch receiver stand 10, such as the insertion portions 28, leg supports 16, and ground supports 18 have generally square cross-sectional, it is understood that other cross-sectional shapes are also suitable. Exemplary cross-sectional shapes are triangular, rectangular, circular, and elliptical. Further, while the stand 10 has been described for use with a vehicle-mountable device having a hitch, it is understand that that stand 10 can mount any device having a hitch sized to be received within the hitch receiver 24.

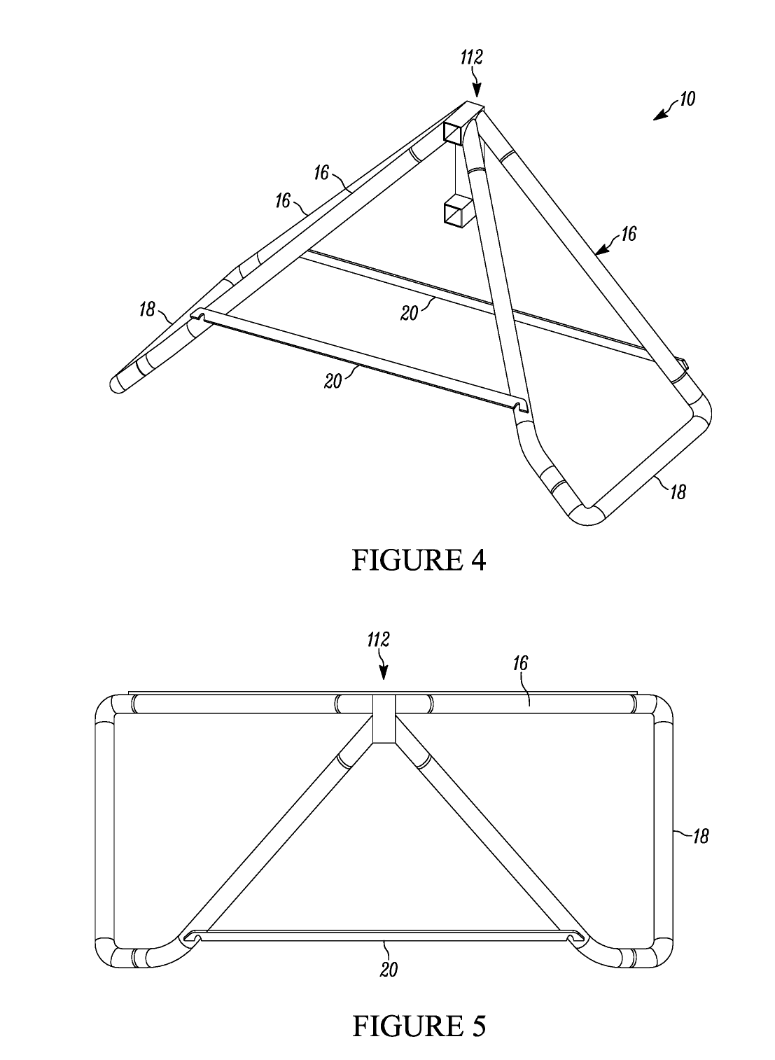

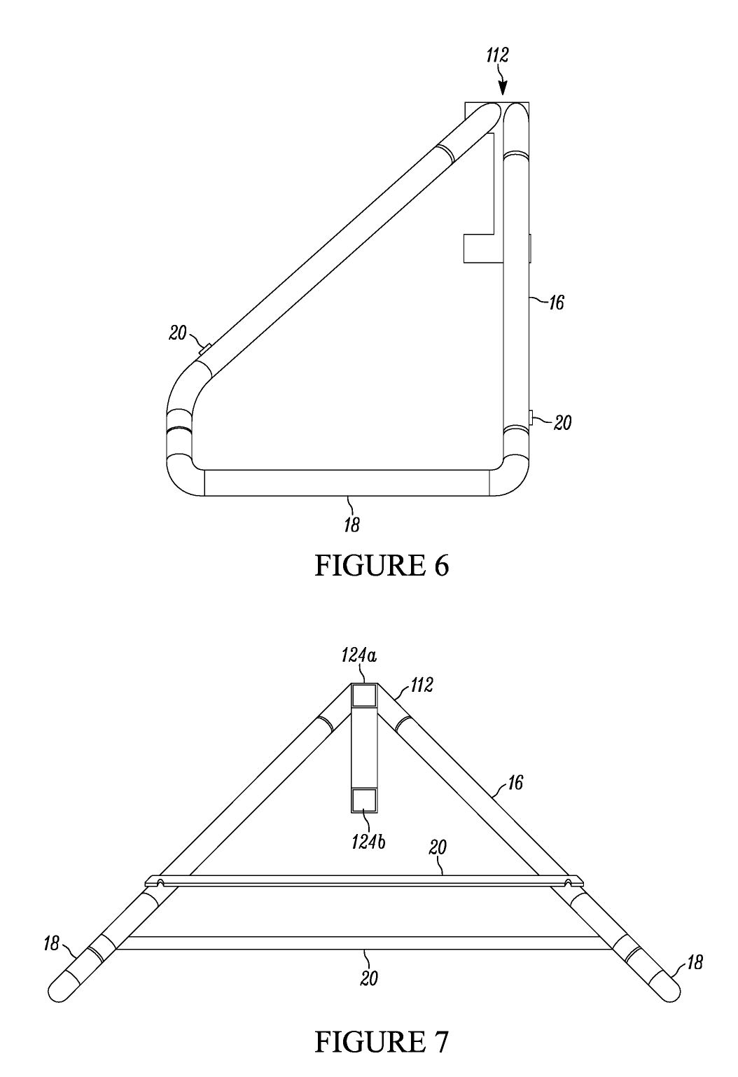

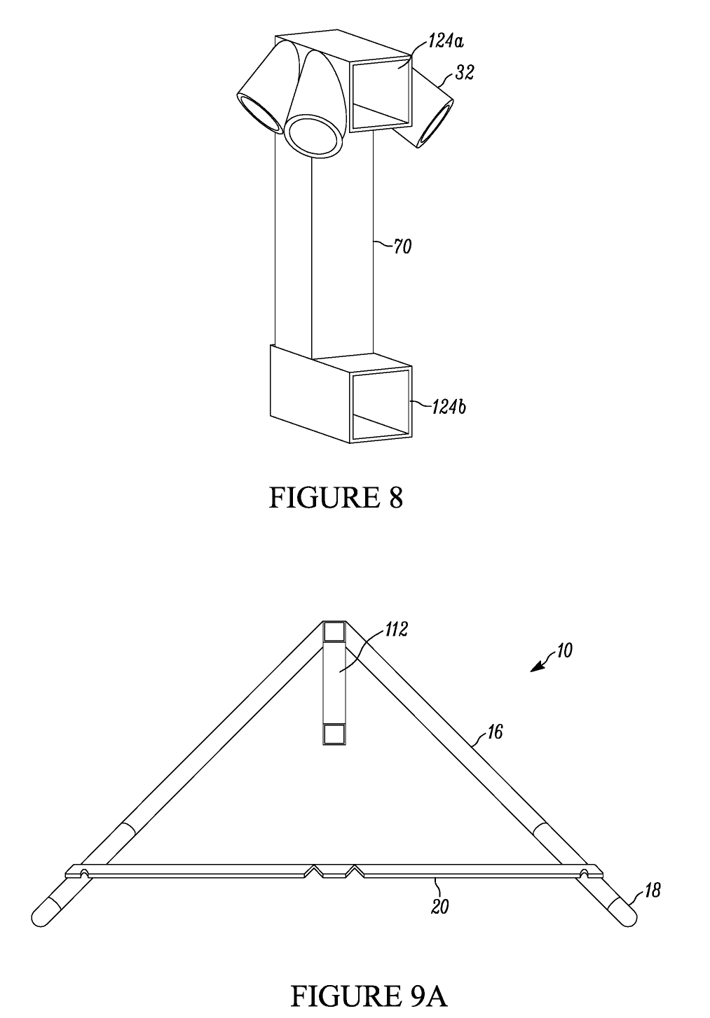

Another configuration is shown in FIGS. 4 through 8. In such a configuration, the leg supports 16 and base supports 18 can be made from a tubular material having a circular cross-sectional configuration. In such a configuration, rather than having the leg supports and base supports formed from a plurality of materials that are welded or otherwise coupled together, the tubular material can be bent and drawn to the correct dimensional configuration. As such, the structure can be simplified from a manufacturing standpoint, for example.

Additionally, in such a configuration, an alternate hitch receiver assembly 112 is shown. Where structures in the hitch receiver assembly are analogous to those of the hitch receiver assembly 12, the same reference number augmented by 100 is utilized. The hitch receiver assembly 112 includes a pair of spaced apart hitch receivers 124a, 124b. The two spaced apart hitch receivers are aligned so that hitch receiver 124a is positioned above hitch receiver 124b. A vertical frame spacer 70 couples the two structures together. The two spaced apart hitch receivers are generally parallel to each other and provide two different coupling regions. It will be understood that the different positions can be helpful one of the hitch receivers may be better positioned to receive and hold certain structures, while others are better suited for coupling to another one of the hitch receivers. It will further be understood that more than two hitch receivers in different positions can be provided (which may or may not be aligned vertically), where, the hitch receivers can be of different length and position to maximize the utility of the same, and to allow simultaneous coupling of multiple devices to the hitch.

In the configuration shown, the two spaced apart hitch receivers are shortened so as to allow for the passage of a hitch attachable component entirely through the hitch receiver. Such a configuration removes the need for holes 30 which would align with corresponding openings, to, in turn, allow for the placement of a pin to lock the structures together. Instead, the opening on the member that is inserted would be visible beyond a back end of the hitch receiver.

Such a configuration of the hitch receiver assemblies allows for the placement of an outside structure in a plurality of orientations, depending on the configuration. Additionally, in other configurations, multiple structures can be attached to the hitch receiver stand, one to each of the hitch receivers. Additionally, in the configuration shown, the inserts 132, actually extend over a portion of the leg supports (i.e., the leg supports are inserted into the inserts 132). It will be understood that the component that is inserted into a component to which it is attached can be varied depending on the particular application. Furthermore, other types of coupling are contemplated, such as other mating configurations. Furthermore, it is contemplated that the leg supports and the base supports can be integrally formed or coupled together in a manner which precludes decoupling. The inserts are but one of the different coupling structures that are disclosed.

It will be understood that the hitch receiver assembly and the insert receivers can be cooperatively organized so that the hitch receiver assembly is positioned in a plurality of orientations relative to the footprint defined by the area bounded by the base supports. Advantageously, in the configuration shown, the hitch receiver is positioned proximate the center and back of the footprint so that the device that is coupled to the hitch receiver can have a large portion thereof overlying the footprint of the base supports (in such a configuration), the rear leg supports can be define a plane that is generally perpendicular to the ground, with the front leg supports defining a plane that is oblique to the rear leg supports. In one such configuration, the relative angle between the front and rear leg supports can be on the order of 39° while other angles are contemplated. Additionally, the left and right leg supports can be oblique to the vertical and to the ground at, for example, an angle of 45° relative to the horizontal (or the vertical). Other angles of inclination are likewise contemplated. In such a manner, stability of the system can be maintained.

It will be understood that the base supports can further be coupled to the ground through spikes or other structures (i.e., hammered into the ground) to maintain the hitch receiver stand in the desired orientation, and to aid stability. In other configurations, the position of the hitch receiver relative to the footprint can be altered depending on that which is desired. It will further be understood that the angles of the leg supports can be varied to achieve different configurations with different stability characteristics. While not required, it is generally desirable to maintain the structure coupled to the hitch receiver in an orientation that overlies the footprint.

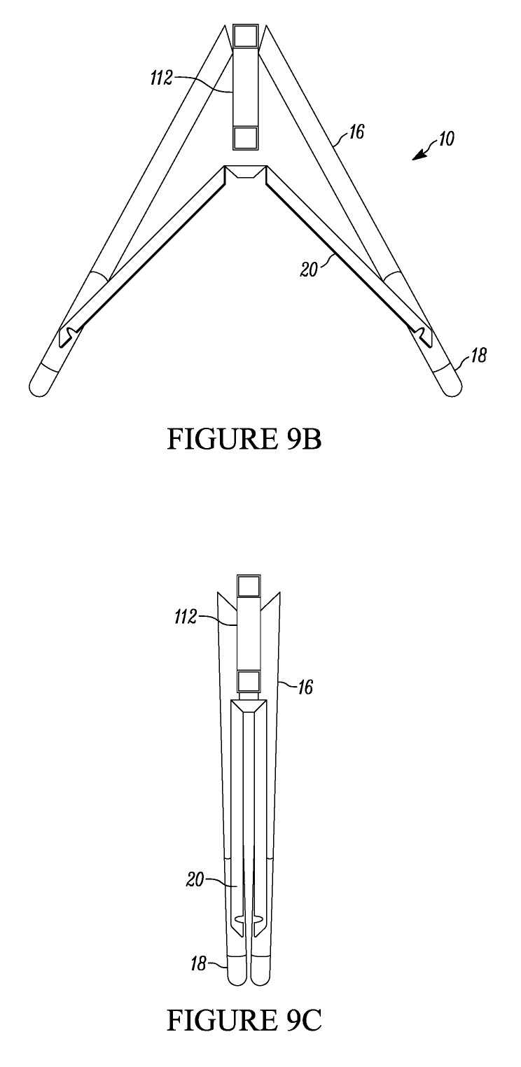

With reference to FIGS. 9a through 9c, it is also contemplated that the leg supports may be hingedly attached to the hitch assembly so that they can be pivoted between a folded and an articulated configuration about the hinges. In such a configuration, the leg supports may or may not be permanently attached to the hitch assembly. In such a configuration, the different components are hinged together to so that the same can be articulated or collapsed.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A hitch receiver stand comprising:
a hitch receiver assembly including at least one hitch receiver defining a passage; and
a plurality of leg supports coupled to the hitch receiver, the leg supports configured to support the hitch receiver assembly off a ground surface so that the hitch receiver is spaced apart therefrom.

2. The hitch receiver stand of claim 1 wherein the plurality of leg supports further comprise a pair of first side leg supports and a pair of second side leg supports, each of the leg supports extending oblique to the hitch receiver.

3. The hitch receiver stand of claim 2 wherein the first side leg supports define a first side plane and the second side leg supports define a second side plane, the first and second side planes being oblique to each other.

4. The hitch receiver stand of claim 3 wherein the first side leg supports and the second side leg supports are mirror images of each other taken about a plane bisecting the hitch receiver.

5. The hitch receiver stand of claim 3 further comprising a first base support extending between the pair of first side leg supports, proximate a distal end thereof, and a second base support extending between the pair of second side leg supports.

6. The hitch receiver stand of claim 5 wherein the first base support is releasably attachable to each of the pair of first side leg supports, and the second base support is releasably attachable to each of the pair of second side leg supports.

7. The hitch receiver stand of claim 6 wherein the pair of first side leg supports are releasably attachable to the hitch receiver assembly and the pair of second side leg supports are releasably attachable to the hitch receiver assembly.

8. The hitch receiver stand of claim 3 further comprising a brace that extends between the pair of first leg supports and the pair of second leg supports.

9. The hitch receiver stand of claim 1 wherein the hitch receiver further includes a plurality of inserts, each of which extends outwardly therefrom, with the plurality of leg supports attachable to one of the plurality of inserts.

10. The hitch receiver stand of claim 9 wherein each of the plurality of leg supports extends one of inside one of the plurality of inserts, and, over one of the plurality of inserts.

11. The hitch receiver stand of claim 1 wherein the at least one hitch receiver comprises at least two hitch receivers configured in a spaced apart configuration.

12. The hitch receiver stand of claim 11 wherein the at least two hitch receivers comprises two hitch receivers that are aligned vertically and spaced apart from each other, and substantially parallel to each other.

13. The hitch receiver stand of claim 12 wherein the plurality of leg supports are coupled to the hitch receiver assembly proximate an upper one of the at least two hitch receivers.

14. The hitch receiver stand of claim 1 wherein the plurality of leg supports comprises four leg supports.

15. The hitch receiver stand of claim 13 wherein the four leg supports define a footprint, with the hitch receiver assembly being positioned within the footprint defined by the four leg supports.

16. The hitch receiver stand of claim 1 wherein the hitch receiver further includes a flat plate extending thereover.

17. The hitch receiver stand of claim 1 wherein the leg supports are configured to maintain the passage of the hitch receiver in a substantially parallel orientation relative to the ground surface.

18. The hitch receiver stand of claim 1 wherein the leg supports have a circular cross-sectional configuration.

19. The hitch receiver stand of claim 1 wherein the plurality of leg supports are releasably coupled to the hitch receiver assembly.

20. The hitch receiver stand of claim 19 further comprising a plurality of base supports, each base support releasably coupled to a distal end of at least one of the plurality of leg supports.
